(19) United States
(12) Patent Application Publication
(10) Pub. No.: US 2018/0186397 A1
(43) Pub. Date: Jul. 5, 2018

(54) FORM FITTED ANTIMICROBIAL STEERING WHEEL COVER FOR USE IN A VARIETY OF SETTINGS

(71) Applicant: Daren Anderson, Waxhaw, NC (US)

(72) Inventor: Daren Anderson, Waxhaw, NC (US)

(21) Appl. No.: 15/397,305

(22) Filed: Jan. 3, 2017

(51) Int. Cl. B62D 1/06; C09D 5/16

(52) U.S. Cl. CPC B62D 1/06; C09D 5/1662

(57) ABSTRACT

Embodiments described herein provide a form fitted antimicrobial steering wheel cover dimensioned to fit a plurality of varying sized steering wheel. The inside surface is configured of an elastic material which enables stretching around the circumference of a steering wheel. The outside surface includes a silane based antimicrobial coating portion which inhibits and destroy micro-organism from being transferred to the hands of the user when gripping the cover.

### FIELD

The embodiments presented provide a form fitted antimicrobial steering wheel cover, and in particular, to a form fitted antimicrobial steering wheel cover comprised of at least one layer of elongated and elastic material which may be releasably fitted to a variety of steering wheel dimensions and provide a sterile environment to the hands of the user.

### BACKGROUND

Steering wheels are used on nearly every type of motorized vehicle today. Their designs and dimensions are often a result of the vehicle type of purpose but generally are comprised in a circular shape and attached a stem at center of the steering wheel

In a commercial environment, a steering wheel may be gripped by a plurality of drivers who are exposed to thousands of germs and microorganism throughout the course of the day. As more of these driver grab the well, these dangerous bacteria strands are transferred from one driver to another throughout the day.

In addition to these dangerous microorganism, the sweat and oil from each driver hands both deform and breakdown the material of the steering well often leading to cracking or discoloration. One solution often found at retail locations is a steering wheel cover comprised of leather or a leather substitute. These covers are designed to be wrapped around the steering wheel to help protect the material from the wear and tear.

Though there are several steering wheel cover comprised of various material such as U.S. Pat. No. 5,743,154 to Jacinth; U.S. Pat. No. 5,511,445 to Hildebrandt; and U.S. Pat. No. 8,101,887 to Pate; there is not single reference which provides a form fitted and elastic steering wheel cover which allows use on a variety of sized steering wheels and further includes a antimicrobial coating on the outside surface to prevent and eliminate dangerous bacteria and germs while gripping the steering wheel cover.

### SUMMARY OF THE INVENTION

Embodiments described herein provide for a form fitted antimicrobial steering wheel cover which may be used with a variety of various sized steering wheels. The cover is substantially annular with both an inner and outer layer affixed along a first and second seem. The inner layer and the outer lay of the cover are comprised of an elastic material which enables the user to stretch the cover onto a plurality of varying sized steering wheels by pulling along the perimeter of the cover. In one embodiment, the cover is comprised of a non-woven neoprene material further including a silane based antimicrobial coating along the outside perimeter to destroy microorganism and inhibit the spread of dangerous bacteria. The breathable inner and outer layers further enable a user to remove and wash the cover in using at a washing machine.

The inner and outer layers are further configured to allow the cover to “breathe” and allow any condensation trapped along the outside surface of the steering wheel and inner surface of the cover to evaporate before the damp material leads to mold and mildew growth. The outer layer of the cover further enables the user to affix a plurality of customized logos through heat transfer or embroidery.

In an alternative embodiment, the form fitted antimicrobial steering wheel cover is comprised of an ultra-violet resistance solution-die elastic fiber material which allows the cover to be stretched to fit a plurality of varying sized steering wheels and further including a organosilane based antimicrobial nanocoating along the perimeter of the cover which inhints the growth of microorgansims from being transferred from a steering wheel the to the hands of the user (i.e., driver).

Other aspects, advantages, and novel features of the embodiments will become apparent from the following detailed description in conjunction with the drawings.

### BRIEF DESCRIPTION OF THE DRAWINGS

A more complete understanding of the embodiments, and the attendant advantages and features thereof, will be more readily understood by reference to the following detailed description when considered in conjunction with the accompanying drawings wherein:

FIG. 1 is a cross-sectional view of a form fitted antimicrobial steering wheel cover;

FIG. 2 is a planar view of the cover;

FIG. 3 is a further view of the cover;

FIG. 4 is a view of the inner side view of the cover; and

FIG. 5 is a view of the cover being releasably attached to a steering wheel.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

The embodiments provided describe a form fitted antimicrobial steering wheel cover which may be used with a plurality of varying sized steering wheels. The cover is designed in annular configuration and comprised of an inside surface layer and outside surface layer affixed at both a leading and trailing hem. The outside surface of the cover further includes a organosilane based antimicrobial nanocoating agent which destroys and inhibits the growth of microorganisms.

Traditional steering wheel covers are comprised of a leather or synthetic leather material which provides enhanced grip and comfort. In addition, these tradition devices provided protections from harmful sunrays and cold weather which often lead to cracking and peeling over time. As these exterior surface materials breakdown and expose the inner layer materials, harmful bacteria, viruses and fungi are captures and spread amongst user who grip the steering wheel. As many of these traditional designs are found in recreational and fleet vehicles, the transfer of these harmful microorganism between user is inevitable.

The embodiments shown provide a steering wheel cover comprised of at least one layer of flexible material to form an annularly configured housing which may be stretched to fit a plurality of varying sized steering wheels. The cover further includes a antimicrobial nanocoating along the textured and adhesive outer layer to prevent the growth and transfer of harmful microorganisms which further prevents these potentially deadly strains from being spread.

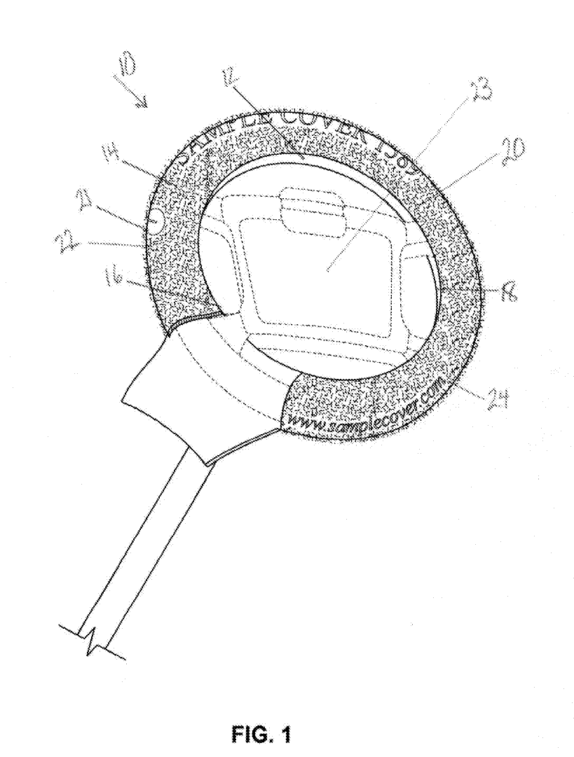

Referring now to the drawings wherein like reference numerals designate identical or corresponding parts throughout the views. There is shown in FIG. 1 a form fitted antimicrobial steering wheel cover 10 for use in variety of settings. The cover 10 is comprised of at least an inner layer 12 and a outer layer 14 of flexible and elastic material which are affixed to each other at a leading hem 16 and trailing hem 18. The leading hem 16 and trailing hem 18 are opposite each other and define the width of the cover 20 and comprised of a plurality of forward straight stitches laterally spaced to adjoin the inner layer 12 to the outer layer 14. When releasably attached about the perimeter of a steering wheel 21, the cover 12 substantially encompasses the diameter of the steering wheel 12 and further protrudes inward toward the axial center of the steering wheel 23. The portion protruding inward is proportional to the circumference of the steering wheel 22. It is contemplated the cover 10 is comprised of a breathable and memory forming neoprene material having a organosilane based antimicrobial nanocoating 24 along a portion of the outer 14. However, any synthetic rubber material may be used as long as its flexible, breathable, and may form a contoured and memory shaped wrapping about the perimeter of the plurality of varying sized steering wheels 22.

Further illustrated in FIG. 1 is the application of the cover 10 releasably attached onto the 12.5 inch diameter of a recreational golf cart. The inner layer 12 and outer layer 14 are configured from a breathable and memory forming material which allow any condensation trapped between the cover 12 and steering wheel 22 to be evaporate without forming harmful fungi. Further, when releasably attached to a steering wheel 22, the memory forming material forms a contoured fit to prevent slipping.

The outer layer 14 further includes a textured antimicrobial nanocoating agent which destroys any microorganism collected on the steering wheel and prevents the colonization of harmful bacteria. Specifically, an organosilane based polymer is coated along the textured and adhesive outer layer 14 which sanitizes the user hands when gripping. As with many fleet vehicles which are operated by carriers who often deliver hundreds of packages and cardboard boxes in a shift, preventing the transfer of harmful bacteria and viruses between coworkers and customers is vital to safety and productivity.

Further illustrated in FIG. 1 is the cover 10 having a customized logo affixed to the outer layer 14. The cover 10 may be manufactured with a variety of color schemes, sports logos, or advertising material. Or purchased separately by a user and applied through heat transfer or embroidery.

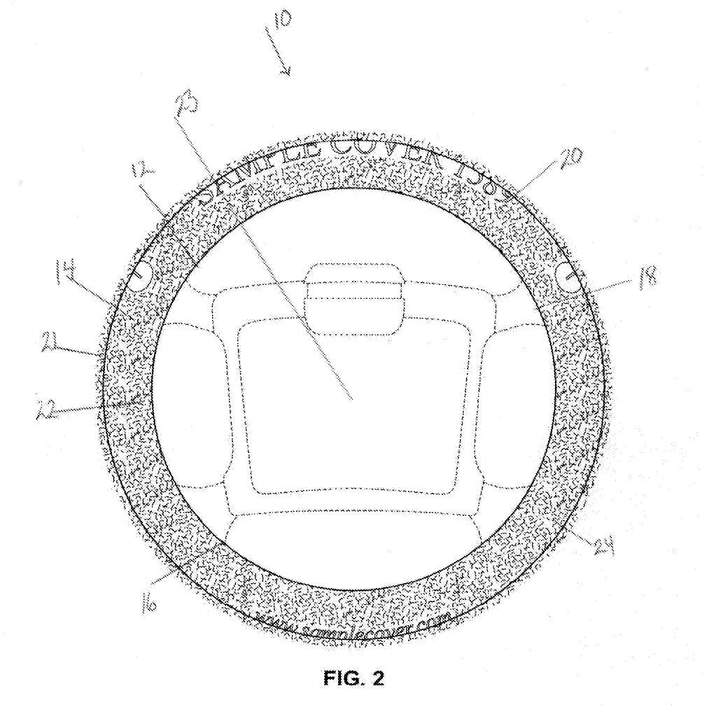

Now shown in FIG. 2 and planar view of the cover 10 releasably attached on the steering wheel 22 of a recreational golf cart. In the present embodiment, the cover 10 may be customized for an individual golfer whose name and title may be placed along the outer layer 14.

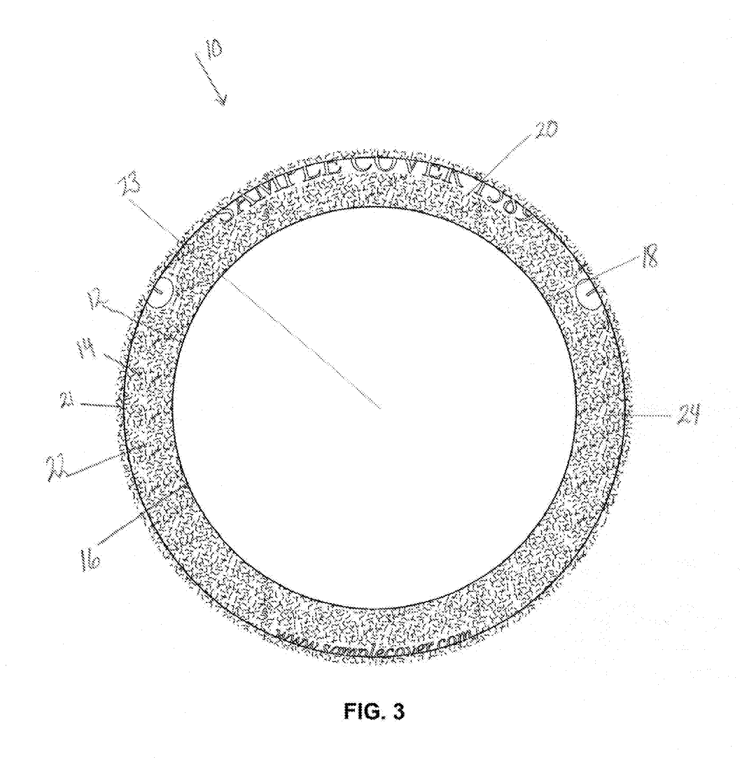

Now shown in FIG. 3 is a view of the cover 10 releasably detached from a steering wheel 22. The cover 10 may be easily removed and cleaned in a washing machine and air dried for future use. The cover 10 which is comprised of an elastic and breathable material is able to rapidly dry if exposed to rain and further allows for any condensation trapped between the inner layer 12 and steering wheel to evaporate. Should moisture collect on the inner layer 12, which is opposite the outer layer 14, any microorganism which be destroyed when exposed to the organosilane agent.

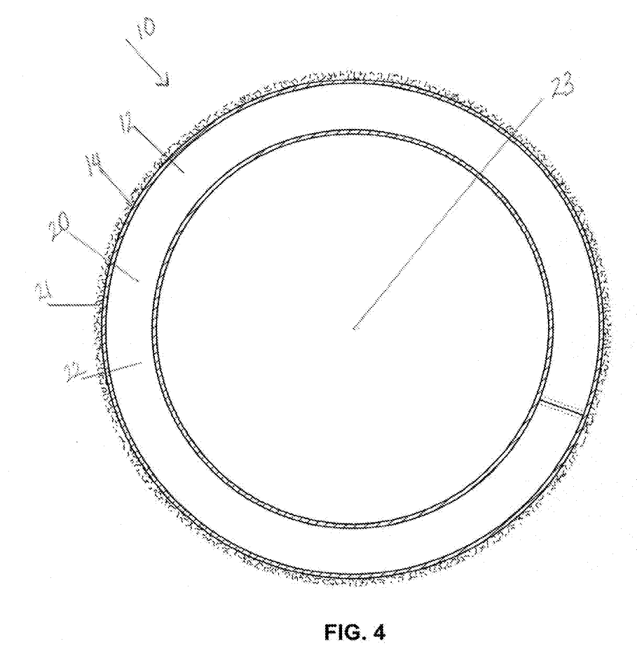

Now shown in FIG. 4 is a view of the inner layer 12 and leading hem 16 and trailing hem 18 which allow the cover 10 to be secured onto the steering wheel 22 without the use of hook and fasteners.

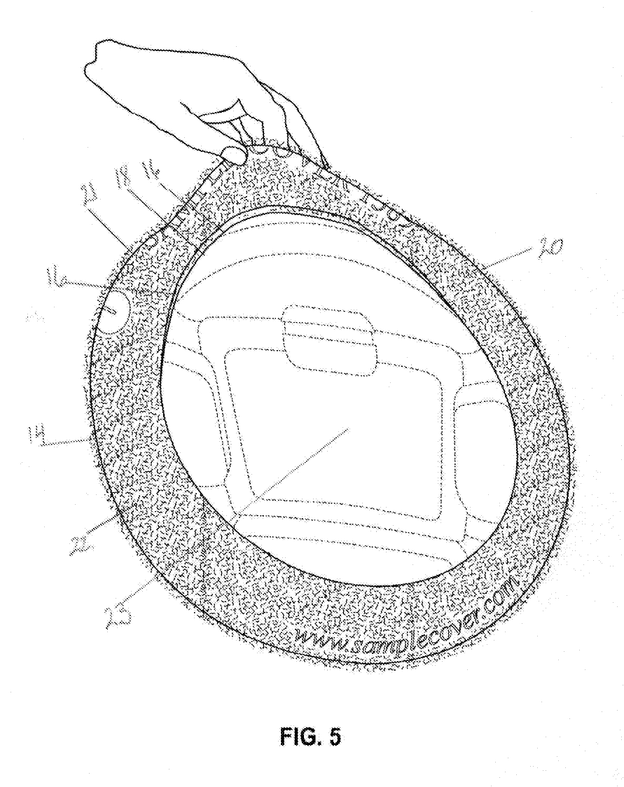

Now shown in FIG. 5 is view of cover 10 be releasably attached to the steering wheel 22. The user is able to apply the cover 10 by first placing a portion of the cover 10 along the perimeter of the steering wheel 21. Once partially secured onto the steering wheel 10, the elastic material which is configured to laterally stretch by first applying a portion of the cover around the perimeter of the steering wheel 21 and stretching the remaining portion around the steering wheel until evenly aligned.

It will be appreciated by persons skilled in the art that the present embodiment is not limited to what has been particularly shown and described hereinabove. In addition, unless mention was made above to the contrary, it should be noted that all of the accompanying drawings are not to scale. A variety of modifications and variations are possible in light of the above teachings without departing from the following claims.

What is claimed is:

1. A form fitted antimicrobial steering wheel cover cover, the cover comprising:
at least two elongated and elastic material layers affixed a leading hem and a trailing hem and annularly configured to form a memory shaped housing about a perimeter of a steering wheel; the at least two elongated and elastic material layers layers further including an antimicrobial textured portion to prevent the transfer of at least one microorganism to the hands of user when gripping a steering wheel.

2. The cover of claim 1, wherein the leading hem and the trailing hem are opposite each other and further define a width of the cover.

3. The cover of claim 2, wherein the antimicrobial textured portion of the outer layer is organosilane based nanocoating polymer.

4. The cover of claim 3, wherein the at least two elongated and elastic material layers further includes a polymer or a synthetic rubber.

5. The cover of claim 1, wherein the outer layer further enables a user to affix a plurality of customized logo through a heat transfer means.

6. A form fitted antimicrobial steering wheel cover, the cover comprising:
an annularly shaped housing comprised of at least an inner layer and outer layer of elongated and flexible synthetic rubber material configured to form a contoured and memory shaped wrap about a perimeter of a steering wheel, the outer layer of elongated and flexible synthetic rubber material further including a silane based textured antimicrobial nanocoating to inhibit a transfer of bacteria to a users hand when gripping the steering wheel.

7. The cover of claim 6, wherein the antimicrobial textured portion further includes a organosilane based nanocoating polymer about an outer layer to prevent a spread of a microorganism to a hand of a user.

8. The cover of claim 6, wherein the inner layer and the outer layer are comprised of a flexible water resistance polymer material to create a form fit on at least a steering wheel of a golf cart.

9. The cover of claim 8, wherein the flexible water resistant polymer material further allows for a plurality of customized logos to be affixed using a heat transfer means.

10. A form fitted steering wheel cover having a organosilane based nanocoating polymer about a portion of the outer layer, the cover comprising:
a circular shaped housing comprised of at least an inner layer and outer layer of flexible synthetic polymer material configured to create a memory shaped and form fitted water resistant wrap dimensioned to fit about a perimeter of at least a golf cart steering wheel.
